(19) United States
(12) Patent Application Publication
(10) Pub. No.: US 2025/0028152 A1
(43) Pub. Date: Jan. 23, 2025

(54) F-THETA OBJECTIVE AND SCANNER DEVICE EQUIPPED THEREWITH

(71) Applicant: TRUMPF Laser GmbH, Schramberg (DE)

(72) Inventors: Julian Hellstern, Rottweil (DE); Timo Flaig, Fluorn-Winzeln (DE); Tobias Marte, Lauterbach (DE)

(21) Appl. No.: 18/826,218

(22) Filed: Sep. 6, 2024

Related U.S. Application Data
(63) Continuation of application No. PCT/EP2023/055090, filed on Mar. 1, 2023.

(30) Foreign Application Priority Data
Mar. 8, 2022 (DE) 10 2022 105 366.0

(51) Int. Cl. G02B 13/00; G02B 9/34; G02B 13/22

(52) U.S. Cl. CPC G02B 13/0005; G02B 9/34; G02B 13/004; G02B 13/0065; G02B 13/22

(57) ABSTRACT

An F-theta objective has precisely three lenses. The three lenses being: a first lens with a first focal length, which is designed as a biconvex lens with a positive refractive power, a second lens with a second focal length, which is designed as a biconcave lens with a negative refractive power, and a third lens with a third focal length, which is designed as a meniscus lens with a positive refractive power. The first lens, the second lens, and the third lens are arranged one behind the other in a beam path and form a lens assembly.

### CROSS REFERENCE TO RELATED APPLICATIONS

This application is a continuation of International Application No. PCT/EP2023/055090 (WO 2023/169890 A1), filed on Mar. 1, 2023, and claims benefit to German Patent Application No. DE 10 2022 105 366.0, filed on Mar. 8, 2022. The aforementioned applications are hereby incorporated by reference herein.

### FIELD

The present disclosure relates to an F-theta objective, and a scanner device equipped therewith.

### BACKGROUND

The literature describes a variety of optical systems with three, four, or five lenses, which are optimized for different purposes.

U.S. Pat. No. 8,497,931 B2 describes an image-taking optical system for a camera, which comprises four lenses in a sequence starting from the object space: a first lens designed as a biconvex lens with a positive refractive power, a second lens with a negative refractive power, which has a concave surface oriented towards the image space, a third lens with a positive refractive power, which has a convex surface oriented towards the image space, and a fourth lens which has a negative refractive power. The optical system should have a short overall length along the optical axis.

For scanner applications, F-theta objectives are used to focus a laser beam in a focal plane. Such F-theta objectives may be optimized with regard to different properties.

CN104317034 A describes an F-theta objective with five lenses, which is intended to enable precise positioning of the laser beam.

U.S. Pat. No. 4,400,063 describes an F-theta objective with four lens assemblies, of which the first lens assembly has a negative refractive power. The F-theta objective described therein should fulfill the F-Theta condition as well as possible.

CN108415147 describes an F-theta objective, which has a first, positive lens in the form of a biconvex lens, a second, negative lens in the form of a biconcave lens and a third, positive lens in the form of a plane convex lens, as well as a protective glass. The F-Theta lens is optimized for drilling applications.

KR102019049996A describes a laser device with an F-theta objective having multiple spherical lenses which are small in size.

US20190187416A1 describes an F-theta objective that has a diffractive optical element and a plurality of spherical lenses. The F-theta objective is designed to produce a diffraction-limited laser spot with high positioning accuracy.

EP1081525 A2 describes an F-theta objective with a first lens assembly having an object-space convex lens with a positive refractive power, a second lens assembly having an object-space concave lens with a negative refractive power, and a third lens assembly with a positive refractive power. The lenses are made of a material with a refractive index greater than two, such as zinc selenide or germanium. In one example, the lenses of the F-theta objective are spherical lenses, wherein the first lens assembly is formed by a meniscus lens, the second lens assembly by a biconcave lens, and the third lens assembly by a meniscus lens with an approximately flat side and a further meniscus lens.

CN109425962 A describes an F-theta objective that has five lenses to create the largest possible scan field with low distortion.

U.S. Pat. No. 4,787,723 describes an F-theta lens system with an ultra-wide scanning angle of up to 45°. The F-Theta lens system comprises: a first lens component with a positive refractive power, which is designed as a meniscus lens, a second lens component with a negative refractive power, which is designed as a meniscus lens, and a third lens component with a positive refractive power, which is designed as a plane convex lens. The F-Theta lens system is designed to enable an imaging quality of the laser beam close to the diffraction limit despite the small number of lenses.

### SUMMARY

In an embodiment, the present disclosure provides an F-theta objective that has precisely three lenses. The three lenses being: a first lens with a first focal length, which is designed as a biconvex lens with a positive refractive power, a second lens with a second focal length, which is designed as a biconcave lens with a negative refractive power, and a third lens with a third focal length, which is designed as a meniscus lens with a positive refractive power. The first lens, the second lens, and the third lens are arranged one behind the other in a beam path and form a lens assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a scanner device of the present disclosure with an F-theta objective;

FIG. 2 shows a schematic representation of an example of an F-theta objective for the scanner device of FIG. 1, which has precisely three lenses, which form a lens assembly;

FIG. 3 shows a schematic representation analogous to FIG. 2, in which the F-theta objective has a lens assembly with three lenses and a fourth lens arranged downstream of the lens assembly in the beam path; and

FIG. 4 shows a schematic representation analogous to FIG. 2, in which the F-Theta objective has a lens assembly with three lenses and a fourth lens arranged upstream of the lens assembly in the beam path.

### DETAILED DESCRIPTION

Aspects of the present disclosure provide an F-theta objective and a scanner device with such an F-theta objective, which have a large scanning field with the most compact design possible.

The disclosure also relates to an F-theta objective which has precisely four lenses. The disclosure further relates to a scanner device for a laser beam with such an F-theta objective for focusing the laser beam in a focal plane.

A first aspect of the present disclosure provides an F-theta objective, which has precisely three lenses, namely: a first lens with a first focal length, which is designed as a biconvex lens with a positive refractive power, a second lens with a second focal length, which is designed as a biconcave lens with a negative refractive power, and a third lens with a third focal length which is designed as a meniscus lens with a positive refractive power, wherein the first, second and third lenses are arranged one behind the other in the beam path and thus form a lens assembly.. Lenses within this disclosure should be understood to mean individual lenses, i.e., single-piece lenses.

The present inventors have recognized that a lens arrangement of three lenses with positive-negative-positive lens refractive powers enables a large scanning field while at the same time remains very compact. In contrast to classic designs of F-theta objectives, in which the first lens has a negative refractive power, by providing a first lens that has a positive refractive power, a significantly lower radial illumination can be achieved on the subsequent lenses. This allows, among other things, smaller lens diameters to be used whilst also complying with mechanical limitations caused by the periphery. The lens assembly described above, which consists of three lenses with positive-negative-positive refractive powers, enables the creation of a flat image field. For the case described here where the F-theta objective has three lenses, it has proven advantageous if the first lens of the lens assembly is a biconvex lens with a positive refractive power.

In one embodiment, the third lens has at least one, in particular precisely one, aspherical lens surface. In the case described here, where the F-theta objective has precisely three lenses, it is advantageous if the third lens of the lens assembly has an aspherical lens surface. With aspherization, i.e., with a suitable deviation from the spherical curvature of the lens surface, imaging errors of the F-theta objective can be corrected.

As described above, the third lens is a meniscus lens, which has one concave curved side and one convex curved side. In the case described here where the F-theta objective has three lenses, the concavely curved side of the meniscus lens typically faces the second lens and, correspondingly, the convexly curved side of the meniscus lens faces away from the second lens.

In a further development of this embodiment, the aspherical lens surface is formed on a side of the third lens facing away from the second lens. As described above, the side of the third lens in the form of the meniscus lens facing away from the second lens typically has a convex curvature. The other lens surface of the third lens, as well as the lens surfaces of the first and second lenses, are typically spherical surfaces.

In a further embodiment, the ratio of the first to third focal lengths to a total focal length of the F-theta objective satisfies the following conditions:

$$0.3 < {f}_{1} / f < 0 \text{.4} ,$$

$$- 0.3 < {f}_{2} / f < - 0 \text{.2} ,$$

$$0.5 < {f}_{3} / f < 0.7 .$$

As is generally customary, the focal lengths f1 to f3 of the three lenses denote the distance of a respective focal point from a main plane of the respective lens. Accordingly, the total focal length refers to the distance of the focal plane or the image field from a substitute main plane of the F-theta objective. The total focal length is the result of the arrangement or the thicknesses of the three lenses in connection with their air distances.

In a further development of this embodiment, the following applies: f1/f=0.36, f2/f=−0.27 and f3/f=0.64.

By selecting the focal lengths within the intervals described above or with the values described above, an ideally diffraction-limited image can be created. The focal lengths of the lenses depend on the refractive index n of the lens material, on their radii of curvature and on their thickness.

In the present disclosure, the material of the lenses is typically a material that has a refractive index n of less than 2.0 due to the high laser power used, e.g. more than 1 kW. As a rule, this is quartz glass, for example synthetic quartz glass, which typically has a refractive index of approx. n=1.46 at the laser wavelengths used here.

A second aspect of the present disclosure relates to an F-theta objective, which has precisely four lenses made of a material with a refractive index of less than 2.0, namely: a first lens with a first focal length, which is designed as a meniscus lens or as a biconvex lens with a positive refractive power, a second lens with a second focal length, which is designed as a biconcave lens with a negative refractive power, a third lens with a third focal length which is designed as a meniscus lens or as a plane convex lens with a positive refractive power, and a fourth lens with a fourth focal length having a positive refractive power, wherein the first, second and third lenses are arranged one behind the other in the beam path and form a lens assembly, and wherein the fourth lens is arranged upstream of the lens assembly or downstream of the lens assembly in the beam path.

In this aspect of the disclosure, the lens surfaces of all four lenses are typically spherical, i.e., the lenses of the F-theta objective do not have aspherical lens surfaces. The material of the lenses can, for example, be (synthetic) quartz glass.

The type of fourth lens with a positive refractive power depends on its arrangement in relation to the lens assembly. If the fourth lens is located upstream of the lens assembly in the beam path, it is typically a biconvex lens. If the fourth lens is located downstream of the lens assembly in the beam path, it is usually a meniscus lens. The meniscus lens has a convex side that typically faces the third lens of the lens assembly.

In one embodiment, the fourth lens is arranged downstream of the lens assembly in the beam path and the ratio of the first to fourth focal lengths to a total focal length of the F-theta objective satisfies the following conditions:

$$0.6 < {f}_{1} / f < 0 \text{.7} ,$$

$$- 0.3 < {f}_{2} / f < - 0.35 ,$$

$$0.55 < {f}_{3} / f < 0.65 ,$$

$$1.6 < {f}_{4} / f < 1.8 .$$

In a further development of this embodiment, the following applies: f1/f=0.63, f2/f=−0.32, f3/f=0.59, f4/f=1.65.

By selecting the focal lengths within the intervals described above or with the values described above, an ideally diffraction-limited image can also be created in this case.

In the case described here, where the fourth lens is arranged downstream of the lens assembly in the beam path, the first lens of the lens assembly is typically a meniscus lens, whose concave side faces the second lens of the lens assembly. The third lens can be a plane convex lens with the convex side facing away from the second lens. Alternatively, the third lens can be a meniscus lens with the convex side facing away from the second lens.

In an alternative embodiment, the fourth lens is arranged upstream of the lens assembly in the beam path and the ratio of the first to fourth focal lengths to a total focal length of the F-theta objective satisfies the following conditions:

$$0.6 < {f}_{4} / f < 0 \text{.8} ,$$

$$1.6 < {f}_{1} / f < 1 \text{.8} ,$$

$$- 0.4 < {f}_{2} / f < - 0.35 ,$$

$$0.7 < {f}_{3} / f < 0.8 .$$

In a further development of this embodiment, the following applies: f4/f=0.70; f1/f=1.73; f2/f=−0.37; f3/f=0.73.

By selecting the focal lengths within the intervals described above or with the values described above, an ideally diffraction-limited image can also be created in the case described here.

With the case described here, in which the fourth lens is arranged upstream of the lens assembly in the beam path, the first lens of the lens assembly is typically a meniscus lens whose concave side faces the second lens. The third lens in the lens assembly is typically also a meniscus lens, with its concave side facing the second lens in the lens assembly; however, this is not necessarily the case.

In another embodiment, the total focal length of the F-theta objective is between 150 mm and 1000 mm. The designs described above are suitable for large deflection angles, i.e., for a large scan or image field, the largest extent of which is typically in the order of magnitude of the total focal length of the F-theta objective. The F-theta objective with precisely three lenses and the F-theta objective described above, in which the fourth lens is arranged downstream of the lens assembly in the beam path, are particularly suitable for total focal lengths between 150 mm and 500 mm. The F-theta objective described above, in which the fourth lens is arranged upstream of the lens assembly, is particularly suitable for total focal lengths between 400 mm and 1000 mm.

In a further embodiment, the F-theta objective is designed as a non-image-space telecentric lens. In such an F-theta objective, the alignment of the laser beam emanating from the entrance pupil of the F-theta objective to the optical axis depends on the angle at which the laser beam is directed onto the focal plane or onto the image field. The laser beam is therefore not always aligned essentially parallel to the optical axis, as is the case with an image-space telecentric F-theta objective, regardless of the deflection angle. In this case, the telecentricity error is of the order of magnitude of the maximum deflection angle, i.e., usually more than 150 or more than 20°. The non-image-space telecentric design of the F-theta objective can be achieved by a suitable choice of the ratios between the focal lengths of the lenses and the total focal length.

In a further embodiment, an entrance pupil plane of the F-theta objective is located at a distance of between 30 mm and 100 mm upstream of the first lens of the lens assembly (if the fourth lens is not arranged upstream of the lens assembly in the beam path) or upstream of the fourth lens arranged upstream of the lens assembly in the beam path. It has proven to be advantageous if the first lens of the F-theta objective, which has a positive refractive power, is arranged as close as possible to the entrance pupil plane.

When using an F-theta objective in a scanner device with two scanner mirrors, the entrance pupil is by definition located precisely between the two scanner mirrors. The distance of the entrance pupil plane from the first (or fourth) lens is typically determined depending on the opto-mechanical boundary conditions: Typically, to avoid the risk of collisions between the scanner mirrors and the first (or fourth) lens of the F-theta objective, the larger the beam diameter of the incoming laser beam, the larger the reflecting surfaces of the scanner mirrors and the greater the distance between the entrance pupil plane and the first lens of the F-theta objective.

The F-theta objective may have at least one protective glass arranged downstream of the lenses in the beam path. The protective glass is typically a plane-parallel plate, i.e., a component which ideally has no optical effect. The protective glass serves to protect the lenses or the F-theta objective from dirt, slag or the like that is formed during a material processing process, for example during a welding or cutting process. In particular, two protective glasses can be arranged downstream of the F-theta objective in the beam path.

The F-theta objective with the parameters described above is optimized for (monochromatic) laser radiation in a wavelength range between 500 nm and 550 nm or between 1000 nm and 1100 nm, in particular between 1030 nm and 1075 nm.

A further aspect of the present disclosure is realized in a scanner device for a laser beam, comprising: at least one scanner mirror for deflecting the laser beam, and an F-theta objective following the at least one scanner mirror in the beam path for focusing the laser beam in a focal plane, wherein the F-theta objective is designed as described above. The laser beam is typically a high-power laser beam with a radiation output of, for example, several kW. The scanner device is usually designed for material processing. Generally, at least one (plane-parallel) protective glass is arranged between the lenses of the F-theta objective and the focus plane or the workpiece. The one or more scanning mirrors are typically arranged in, or in the vicinity of, the entrance pupil plane of the F-theta objective. The scanner apparatus is typically designed to allow the laser beam deflected by the scanning mirror(s) to be incident substantially non-telecentrically over the entire scanning region onto the focus plane, which usually corresponds to a processing plane in the case of material processing and at which a workpiece is arranged.

Further advantages of the present disclosure are evident from the description and the drawings. Likewise, the features mentioned above, and those that are yet to be presented may be used in each case by themselves or as a plurality in any desired combinations. The embodiments shown and described should not be understood as an exhaustive enumeration, but rather are of an exemplary character for describing the disclosure.

In the following description of the drawings, identical reference numerals are used for identical or functionally identical components.

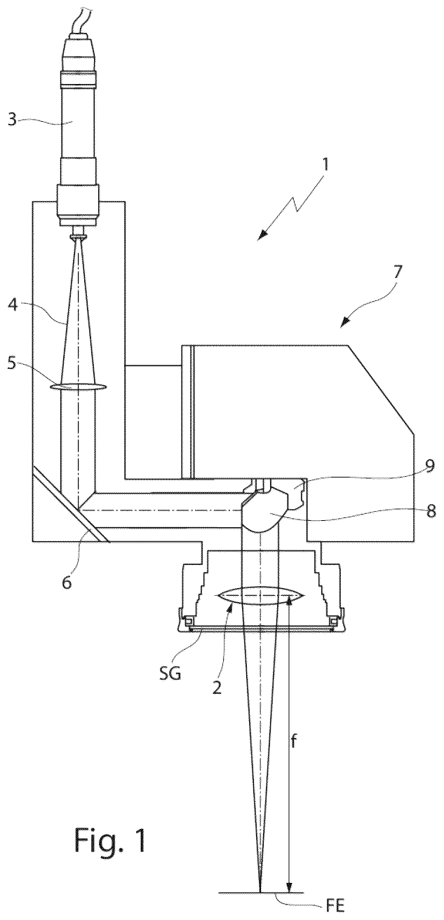

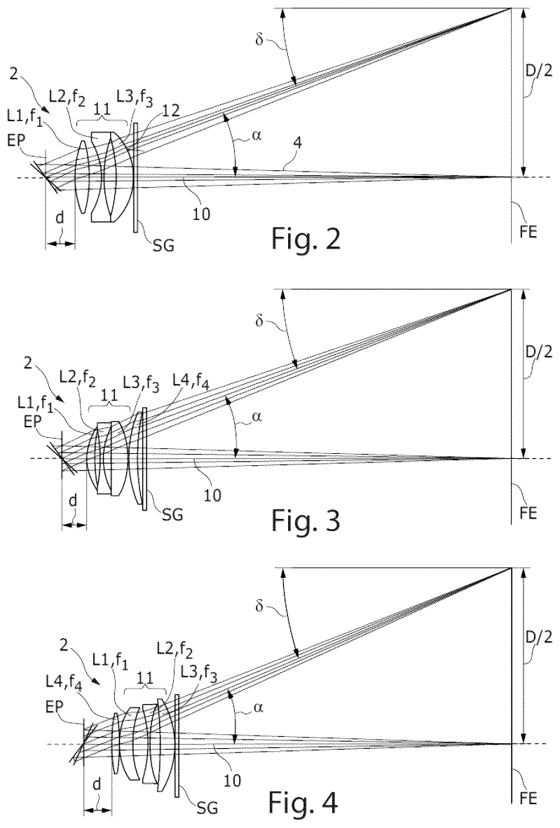

FIG. 1 shows a scanner device 1 for material processing, for example for laser welding or laser cutting, which comprises an F-theta objective 2, which in FIG. 1 is shown in the form of a single lens for simplification and whose structure is described in more detail below in connection with FIGS. 2 to 4. The scanner device 1 has an optical fiber 3, from which a divergent laser beam 4 with a high beam power (>1 kW) emerges, which is transformed by means of a collimation lens 5 into a largely collimated laser beam 4. The collimated laser beam 4 is deflected by 90° at a deflection mirror 6 and enters a scanner head 7 via an entrance aperture. In the scanner head 7, the collimated laser beam 4 is first incident on a planar X-scanner mirror 8, which deflects the beam in the X-direction onto a planar Y-scanner mirror 9, which further deflects the laser beam 4 into the Y-direction. The X-scanner mirror 8 and the Y-scanner mirror 9 are attached to galvanometers, i.e., the latter can be rotated or tilted. The position of the axis of rotation of the galvanometers determines the deflection angle of the respective scanner mirror 8, 9 and thereby the position of the laser beam 4 in the image field, or in the focus plane FE. The collimated laser beam 4 leaves the scanner head 7 through an exit opening to which the F-theta objective 2 is attached which focuses the laser beam 4 onto the focus plane FE in which a workpiece to be processed is arranged during the operation of the scanner apparatus 1.

FIG. 2 shows an example of a design of the F-theta objective 2 of FIG. 1 in a detailed view. The F-theta objective 2 has three consecutive lenses L1, L2, L3 along the optical axis 10 or along the beam path of the laser beam 4, which form a common lens assembly 11. The first lens L1 is designed as a biconvex lens and has a positive refractive power, the second lens L2 is designed as a biconcave lens and has a negative refractive power and the third lens L3 is designed as a meniscus lens and has a positive refractive power.

The third lens L3 has a first, concavely curved side facing the second lens L2 and a second, convexly curved side facing away from the second lens L2. The second, convexly curved side is designed as an aspherical lens surface 12. The lens surfaces of the first and second lenses L1, L2 as well as the concavely curved lens surface of the third lens L3 are designed as spherical surfaces.

In the example shown in FIG. 2, the ratios of the focal lengths f1 to f3 of the three lenses L1 to L3 with respect to a total focal length f of the F-theta objective 2 (cf. FIG. 1) satisfy the following three conditions:

$$0.3 < {f}_{1} / f < 0 \text{.4} ,$$

$$- 0.3 < {f}_{2} / f < - 0 \text{.2} ,$$

$$0.5 < {f}_{3} / f < 0.7 .$$

Specifically, in the example shown: f₁/f=0.36; f₂/f=−0.27; f₃/f=0.64.

FIG. 3 shows an example of an F-theta objective 2 which, in contrast to the F-theta objective 2 shown in FIG. 2, has precisely four lenses L1, L2, L3, L4 which are arranged one behind the other in the beam path. The first, second and third lenses L1, L2, L3 also form a lens assembly 11, which has a positive-negative-positive refractive power: The first lens L1 of the lens assembly 11 is designed as a meniscus lens with a positive refractive power and has a convex lens surface facing away from the second lens L2 and a concave lens surface facing the second lens L2. The second lens L2 is designed as a biconcave lens with a negative refractive power, as in the example shown in FIG. 2. The third lens L3 is typically designed as a meniscus lens with a positive refractive power and has a convex lens surface facing away from the second lens L2 and a concave lens surface facing the second lens L2. It is also possible that the first lens surface of the third lens L3 is designed to be flat, i.e., that the third lens L3 is a plane convex lens with a positive refractive power, as shown in FIG. 3. The fourth lens L4 is a meniscus lens with a positive refractive power. The convex side of the fourth lens L4 faces the third lens L3, while the concave side of the fourth lens L4 faces away from the third lens L3.

In the example shown in FIG. 3, the ratios of the focal lengths f1 to f4 of the four lenses L1 to L4 with respect to a total focal length f of the F-theta objective 2 (cf. FIG. 1) satisfy the following four conditions:

$$0.6 < {f}_{1} / f < 0 \text{.7} ,$$

$$- 0.3 < {f}_{2} / f < - 0.35 ,$$

$$0.55 < {f}_{3} / f < 0.65 ,$$

$$1.6 < {f}_{4} / f < 1.8 .$$

Specifically, in the example shown: f₁/f=0.63, f₂/f=−0.32, f₃/f=0.59, f₄/f=1.65.

FIG. 4 shows an F-theta objective 2 which, like the F-theta objective 2 shown in FIG. 3, has four lenses L1, L2, L3, L4. The first three lenses L1, L2, L3 are arranged one behind the other in the beam path and form a lens assembly 11. The fourth lens L4 is arranged upstream of the lens assembly 11 in the beam path, more precisely upstream of the first lens L1 of the lens assembly 11.

In the example shown in FIG. 4, the first lens L1 of the lens assembly 11 is designed as a meniscus lens with a positive refractive power. The second lens L2 is designed as a biconcave lens with a negative refractive power and the third lens L3 is designed as a meniscus lens with a positive refractive power. The first lens L1 of the lens assembly 11 has a convex lens surface facing away from the second lens L2 and a concave lens surface facing the second lens L2. The convex lens surface of the third lens L3 faces away from the second lens L2 and the concave lens surface of the third lens L3 faces the second lens L2. The fourth lens L4, which is arranged upstream of the lens assembly 11 in the beam path, is designed as a biconvex lens with a positive refractive power.

In the example shown in FIG. 4, the ratios of the focal lengths f1 to f4 of the four lenses L1 to L4 with respect to a total focal length f of the F-theta objective 2 (cf. FIG. 1) satisfy the following four conditions:

$$0.6 < {f}_{4} / f < 0 \text{.8} ,$$

$$1.6 < {f}_{1} / f < 1 \text{.8} ,$$

$$- 0.4 < {f}_{2} / f < - 0.35 ,$$

$$0.7 < {f}_{3} / f < 0.8 .$$

Specifically, in the example shown: f₄/f=0.70; f₁/f=1.73; f₂/f=−0.37; f₃/f=0.73.

The total focal length f of the F-theta objective 2 shown in FIGS. 2 to 4 is between 150 mm and 1000 mm. In the examples shown in FIG. 2 and FIG. 3, the total focal length f is typically in a value range between 150 mm and 500 mm, in the example shown in FIG. 4, the total focal length f is typically in a value range between 400 mm and 1000 mm. The total focal length f, which denotes the distance of the focal plane FE from a substitute main plane of the F-theta objective 2, is shown schematically in FIG. 1.

The three lenses L1 to L3 of the F-theta objective shown in FIG. 2, as well as the four lenses L1 to L4 of the F-theta objective shown in FIG. 3 and FIG. 4, are each made of (synthetic) quartz glass, which is resistant to laser radiation at powers of more than 1 kW. The material of the protective glass SG, as well as the material of the four lenses L1 to L4, is synthetic quartz glass with a refractive index n of 1.46 at the wavelengths at which the F-theta objective 2 is operated. The F-theta objective 2 is designed for monochromatic radiation at wavelengths between 500 nm and 550 nm or between 1000 nm and 1100 nm, in particular between 1030 nm and 1075 nm. For this wavelength range, the F-theta objective 2 produces a diffraction-limited image.

Also shown in FIGS. 2 to 4 is the entrance pupil EP of the F-theta objective 2, which in FIG. 2 and FIG. 3 has a distance d upstream of the first lens L1 of the lens assembly 11, more precisely from the front vertex of the first lens L1 of the lens assembly 11 in the beam path, along the optical axis 10, which is in the order of magnitude of between 30 mm and 100 mm. In the example shown in FIG. 4, the distance d is measured between the entrance pupil EP and the fourth lens L4, more precisely from its front vertex in the beam path, and is also in the order of magnitude between 30 mm and 100 mm.

The F-theta objective 2 has a large scan field or image field, half of whose maximum extension D/2 can be seen in the focal plane FE in FIGS. 2 to 4. The maximum extension D of the scan field is determined by the (maximum) scanning angle α of the laser beam 4 shown in FIGS. 2 to 4 during the movement of the scanner mirrors 8, 9 and is approximately in the order of magnitude of the total focal length f of the F-theta objective 2. As can also be seen in FIGS. 2 to 4, the alignment of the laser beam 4 at the edge of the scanning field, i.e., at the maximum scanning angle α, deviates by an angle (telecentricity error) 6 from an alignment parallel to the optical axis 10, which approximately corresponds to the maximum scanning angle α. In the example shown, the scanning angle α can vary between approximately −20° and 20° or between approximately −30° and 30°. The alignment of the laser beam 4 in the focal plane FE in the F-theta objective shown in FIGS. 2 to 4 is thus dependent on the scanning angle α and varies depending on the position of the laser beam 4 in the focal plane FE.

In summary, a large scan field can be generated in the manner described above when imaging the laser beam 4 using the F-theta objective 2. The use of three or four lenses in the F-theta objective 2 allows for a very compact design and helps to achieve a high transmission due to the fact there are only a few optical interfaces.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An F-theta objective, which has precisely three lenses, the three lenses being:
a first lens with a first focal length, which is designed as a biconvex lens with a positive refractive power,
a second lens with a second focal length, which is designed as a biconcave lens with a negative refractive power, and
a third lens with a third focal length, which is designed as a meniscus lens with a positive refractive power,
wherein the first lens, the second lens, and the third lens are arranged one behind the other in a beam path and form a lens assembly.

2. The F-theta objective according to claim 1, wherein the third lens has an aspherical lens surface.

3. The F-theta objective according to claim 2, wherein the aspherical lens surface is formed on a side of the third lens facing away from the second lens.

4. The F-theta objective according to claim 1, wherein a ratio of the first focal length to the third focal length to a total focal length of the F-theta objective satisfies the following conditions:
$$0.3 < f 1 / f < 0 \text{.4} ,$$
$$- 0.3 < f 2 / f < - 0.2 , and$$
$$0.5 < f 3 / f < 0.7 .$$

5. The F-theta objective according to claim 4, wherein:
$$f 1 / f = 0.36 ,$$
$$f 2 / f = - 0 \text{.27} , and$$
$$f 3 / f = 0.64 .$$

6. An F-Theta objective, which has precisely four lenses made of a material with a refractive index of less than 2.0, the four lenses being:
a first lens with a first focal length, which is designed as a meniscus lens or as a biconvex lens with a positive refractive power,
a second lens with a second focal length, which is designed as a biconcave lens with a negative refractive power,
a third lens with a third focal length, which is designed as a meniscus lens or as a plane convex lens with a positive refractive power, and
a fourth lens with a fourth focal length having a positive refractive power,
wherein the first lens, the second lens, and the third lens are arranged one behind the other in a beam path and form a lens assembly, and
wherein the fourth lens is arranged upstream of the lens assembly or downstream of the lens assembly in the beam path.

7. The F-Theta objective according to claim 6, wherein the fourth lens is arranged downstream of the lens assembly in the beam path, and the ratio of the first focal length to the fourth focal length to a total focal length of the F-Theta objective satisfies the following conditions:
$$0.6 < f 1 / f < 0 \text{.7} ,$$
$$- 0.3 < f 2 / f < - 0.35 ,$$
$$f 3 / f < 0 \text{.65} , and$$
$$1.6 < f 4 / f < 1.8 .$$

8. The F-theta objective according to claim 7, wherein:
$$f 1 / f = 0.63 ,$$
$$f 2 / f = - 0.32 ,$$
$$f 3 / f = 0 \text{.59} , and$$
$$f 4 / f = 1.65 .$$

9. The F-theta objective according to claim 6, wherein the fourth lens is arranged upstream of the lens assembly in the beam path, and the ratio of the first focal length to the fourth focal length to a total focal length of the F-theta objective satisfies the following conditions:
$$0.6 < f 4 / f < 0 \text{.8} ,$$
$$1.6 < f 1 / f < 1 \text{.8} ,$$
$$- 0.4 < f 2 / f < - 0 \text{.35} , and$$
$$0.7 < f 3 / f < 0.8 .$$

10. The F-theta objective according to claim 9, wherein:
$$f 4 / f = 0.70 ,$$
$$f 1 / f = 1.73 ,$$
$$f 2 / f = - 0 \text{.37} , and$$
$$f 3 / f = 0.73 .$$

11. The F-theta objective according to claim 1, wherein the total focal length of the F-theta objective is between 150 mm and 1000 mm.

12. The F-theta objective according to claim 1, which is designed as a non-image-space telecentric lens.

13. The F-theta objective according to claim 1, in which an entrance pupil plane of the F-theta objective is located at a distance of between 30 mm and 100 mm upstream of the first lens of the lens assembly or upstream of the fourth lens arranged upstream of the lens assembly in the beam path.

14. A scanner device for a laser beam, comprising:
at least one scanner mirror for deflecting the laser beam, and an F-theta objective according to claim 1 following the at least one scanner mirror in the beam path for focusing the laser beam in a focal plane.
